(19) United States
(12) Patent Application Publication
(10) Pub. No.: US 2013/0229495 A1
(43) Pub. Date: Sep. 5, 2013

(54) METHOD FOR CALIBRATING AN IMAGING SYSTEM

(71) Applicants: Ali-Reza Bani-Hashemi, Wanut Creek, CA (US); Gerhard Lechsel, Erlangen (DE); Andreas Rau, Erlangen (DE)

(72) Inventors: Ali-Reza Bani-Hashemi, Wanut Creek, CA (US); Gerhard Lechsel, Erlangen (DE); Andreas Rau, Erlangen (DE)

(21) Appl. No.: 13/654,286

(22) Filed: Oct. 17, 2012

Related U.S. Application Data
(60) Provisional application No. 61/605,497, filed on Mar. 1, 2012.

(51) Int. Cl. H04N 13/02

(52) U.S. Cl. 348/47; 348/46; 348/E13.074

(57) ABSTRACT

In order to increase the accuracy of the calibration of an imaging system of a radiation treatment system operable to generate a treatment beam, an imaging device generates first data representing a reticle disposed in a beam path of the treatment beam. A first transformation between at least two dimensions of a coordinate system of a radiotherapy device of the radiation treatment system and a two-dimensional (2D) image coordinate system for the imaging device is determined based on the first data. The imaging device generates second data representing a phantom including a plurality of markers. A position of the phantom in the coordinate system of the radiotherapy device is determined based on the second data and the first transformation. A second transformation between three dimensions of the coordinate system of the radiotherapy device and the 2D image coordinate system for the imaging device is determined based on the second data and the determined position of the phantom.

This application claims the benefit of U.S. Provisional Application No. 61/605,497, filed Mar. 1, 2012, which is hereby incorporated by reference.

### FIELD

The present embodiments relate to a method for calibrating an imaging system.

### BACKGROUND

For accurate treatment with radiation, a patient position is determined. The patient position is determined with two-dimensional (2 D) or three-dimensional (3D) computed tomography (CT) images generated by an imaging device. In order to determine the patient position, the imaging device is calibrated. For example, transformations from an isocentric coordinate system (e.g., a coordinate system of a radiotherapy device used to treat the patient with radiation) to a coordinate system of the 2D images and/or a coordinate system of the 3D images are determined.

The imaging device may be calibrated by imaging a phantom with markers. A position of the phantom, however, has to be known. The position of the phantom may be known, for example, by aligning the phantom to room-lasers identifying an isocenter of the radiotherapy device. This alignment ties the calibration of the imaging device to the accuracy of the room-lasers and the quality of the alignment by the user.

### SUMMARY

In order to increase the accuracy of the calibration of an imaging system of a radiation treatment system operable to generate a treatment beam, an imaging device of the imaging system generates first data representing a reticle disposed in a beam path of the treatment beam. A first transformation between at least two dimensions of a coordinate system of a radiotherapy device of the radiation treatment system and a two-dimensional (2D) image coordinate system for the imaging device is determined based on the first data. The imaging device generates second data representing a phantom including a plurality of markers. A position of the phantom in the coordinate system of the radiotherapy device is determined based on the second data and the first transformation. A second transformation between three dimensions of the coordinate system of the radiotherapy device and the 2D image coordinate system for the imaging device is determined based on the second data and the determined position of the phantom.

In one aspect, a method for calibrating an imaging system of a radiation treatment system includes receiving, from a first imaging device of the imaging system, first scan data of a reticle disposed in a beam path of a treatment beam. A radiation treatment device of the radiation treatment system is operable to generate the treatment beam. The method also includes determining a first transformation based on the first scan data. The first transformation is between at least two dimensions of a first coordinate system and a second coordinate system. The first coordinate system is a coordinate system of the radiation treatment device. The second coordinate system is an image coordinate system of the first imaging device. The method includes receiving, from the first imaging device, second scan data. The second scan data is of a phantom including at least one marker. The method also includes determining a position of the phantom in the first coordinate system based on the first transformation and the second scan data. The method includes determining a second transformation based on the second scan data and the determined position of the phantom. The second transformation is between three dimensions of the first coordinate system and the second coordinate system.

In another aspect, a system for calibrating an imaging system of a radiation treatment system is provided. The radiation treatment system is operable to irradiate a patient with a treatment beam from a plurality of different directions relative to the patient. The system includes an input operable to receive first scan data from a first imaging device of the imaging system. The first scan data represents a reticle as scanned from a first subset of directions of the plurality of different directions. The reticle is disposed in a beam path of the treatment beam. The input is also operable to receive second scan data from the first imaging device. The second scan data represents a phantom as scanned from a first plurality of directions relative to the phantom. The phantom includes a plurality of markers. The input is operable to receive third scan data from a second imaging device of the imaging system. The third scan data represents the phantom as scanned from a second plurality of directions relative to the phantom. The system also includes a processor configured to determine a first transformation based on the first scan data. The first transformation is between at least two dimensions of a first coordinate system and a second coordinate system. The processor is also configured to determine a position of the phantom in the first coordinate system based on the first transformation and the second scan data, and determine a second transformation based on the second scan data and the determined position of the phantom. The second transformation is between three dimensions of the first coordinate system and the second coordinate system. The processor is configured to determine a third transformation based on the determined position of the phantom and the third scan data. The third transformation is between three dimensions of the first coordinate system and a third coordinate system.

In yet another aspect, in a non-transitory computer-readable storage medium that stores instructions executable by one or more processors to calibrate an imaging system of a radiation treatment system, the instructions include identifying first scan data for a reticle disposed in a beam path of a treatment beam of the radiation treatment system. The instructions also include determining a first transformation based on the first scan data. The first transformation is between at least two dimensions of a first coordinate system and a second coordinate system. The instructions include identifying second scan data. The second scan data is for a phantom including at least one marker. The instructions also include determining a position of the phantom in the first coordinate system based on the first transformation and the second scan data, and determining a second transformation based on the second scan data and the determined position of the phantom. The second transformation is between three dimensions of the first coordinate system and the second coordinate system. The instructions also include identifying third scan data and determining a third transformation based on the determined position of the phantom and the third scan data. The third scan data is for the phantom, and the third transformation is between three dimensions of the first coordinate system and a third coordinate system. The instructions include determining a fourth transformation based on the third transformation. The fourth transformation is between at least two dimensions of the first coordinate system and the third coordinate system.

### BRIEF DESCRIPTION OF THE DRAWINGS

FIG. 1 shows one embodiment of an image-guided system for irradiating a target volume with a treatment beam; and

FIG. 2 shows a flowchart of one embodiment of a method for calibrating an imaging system of the image-guided system of FIG. 1.

### DETAILED DESCRIPTION OF THE DRAWINGS

A radiation treatment device such as, for example, ARTISTE™ by Siemens includes an imaging system having two imaging devices (e.g., an MV imaging device and a kV imaging device). The imaging system includes two flat panel detectors for imaging; one of the two flat panel detectors is for imaging with a treatment beam (e.g., imaging with MV energy to generate MV images), and the other of the two flat panel detectors is for imaging with kV energy (e.g., to generate kV images). Transformations are determined between the MV images (e.g., 2D MV images and 3D MV images) and an isocentric coordinate system (e.g., a coordinate system of the radiation treatment device) and between the kV images (e.g., 2D kV images and 3D kV images) and the isocentric coordinate system. The transformations may be determined for any projection angle of the imaging system relative to the patient region.

To determine the transformations and thus calibrate the imaging system of the radiation treatment device, a reticle is inserted into a beam path of the treatment beam. A cross-hair or other shape of the reticle indicates a projected isocenter from any beam direction of the treatment beam. Projecting the reticle along the beam indicates the iso-center relative to the patient region. The MV imaging device is calibrated using 2D images of the reticle generated by the MV imaging device from various projection angles of the imaging system relative to the patient region. The radiation source of the radiation treatment device generates radiation. The reticle blocks some of the radiation. The detector generates an image of the reticle based on this blocking. The 2D images of the reticle are used to determine a transformation (e.g., a first transformation) between the isocentric coordinate system (e.g., at least two dimensions of the isocentric coordinate system) and a 2D MV image coordinate system (e.g., from the 2D MV image coordinate system to the isocentric coordinate system).

To calibrate the MV imaging device for 3D CT images, 2D images of a phantom are generated by the MV imaging device from various projection angles. The phantom may include a plurality of markers. The first transformation may be used in conjunction with the 2D MV images of the phantom to determine a position (e.g., a 3D position) of the phantom in the isocentric coordinate system. A transformation (e.g., a second transformation) between the isocentric coordinate system (e.g., three dimensions of the isocentric coordinate system) and the 2D MV image coordinate system (e.g., from the isocentric coordinate system to the 2D MV image coordinate system) may be determined using the 2D MV images of the phantom and the position of the phantom in the isocentric coordinate system.

The kV imaging device is calibrated using 2D images of the phantom generated by the kV imaging device. The phantom is in the same position as when the MV imaging device generated 2D images of the phantom. A transformation (e.g., a third transformation) between the isocentric coordinate system (e.g., three dimensions of the isocentric coordinate system) and a 2D kV image coordinate system (e.g., from the isocentric coordinate system to the 2D kV image coordinate system) is determined using the position of the phantom in the isocentric coordinate system and the 2D kV images. A transformation (e.g., a fourth transformation) between the isocentric coordinate system (e.g., at least two dimensions of the isocentric coordinate system) and the 2D kV image coordinate system (e.g., from the 2D kV image coordinate system to the isocentric coordinate system) is determined based on the third transformation.

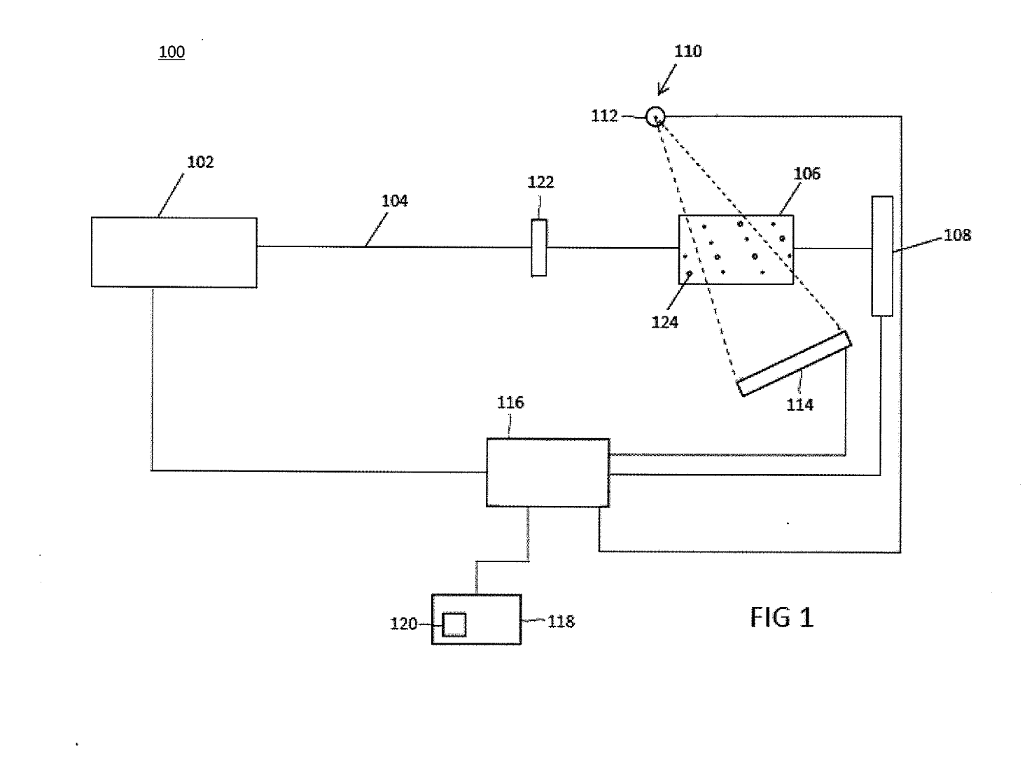

FIG. 1 shows one embodiment of an image-guided radiation therapy system 100 (e.g., a radiation therapy system or a radiotherapy system). The radiation therapy system 100 includes a radiotherapy device 102 such as, for example, a linear accelerator (LINAC) that provides a treatment beam 104 with energy for an irradiation. The LINAC 102 may accelerate electrons to an energy between, for example, 4 and 25 MeV. The accelerated electrons may strike a target made of, for example, Tungsten within or outside of the LINAC 102 to produce a beam of X-rays (e.g., megavoltage (MV) X-rays). The treatment beam 104 may be used to irradiate a target volume 106 located on a table (e.g., a patient table or a patient bed). In one embodiment, the LINAC 102 may include other components such as, for example, scanning magnets, a multileaf collimator, and/or a synchrotron. Other radiotherapy devices such as, for example, electron or ion beam sources, Cobalt-based radiation therapy or radiation surgery systems, and particle therapy systems may be used. The treatment beam 104 may include charged particles such as, for example, electrons, protons, pions, helium ions, carbon ions, or ions of other elements. The radiation therapy system 100 may, for example, be an ARTISTE™ radiation therapy system made by Siemens.

The target volume 106 may, for example, be tumor-diseased tissue of the patient. The radiation therapy system 100 may also be used, for example, to irradiate a non-living body such as, for example, a phantom including a plurality of markers (e.g., as shown in FIG. 1). Other types of phantoms or cell cultures for research or maintenance purposes may be used. Objects that form the target volume 106 may be stationary or moving bodies (e.g., a tumor within a lung of the patient that moves due to breathing). The target volume 106 may be part of the patient that moves (e.g., a tumor in the arm, leg or head that may move due to patient voluntary motion). The target volume 106 may be non-visibly located inside a target object (e.g., the patient).

The radiotherapy system 100 includes a first imaging device (e.g., an MV imaging device) having a first source and a first detector 108. The LINAC 102 may be the first source. For example, the first detector 108 may generate two-dimensional (2D) datasets representing the target volume 106 based on the treatment beam (e.g., the MV X-rays) or other beams generated by the LINAC 102.

The first detector 108 may, for example, be a flat-panel detector. In one embodiment, the first detector 108 includes a scintillator layer and solid-state amorphous silicon photodiodes deployed in a two-dimensional array. In another embodiment, the MV X-rays are absorbed directly by an array of amorphous selenium photoconductors. The photoconductors convert the MV X-rays directly to stored electrical charge that represents an acquired image of the target volume 106. Other detectors may be used.

In one embodiment, the LINAC 102 may irradiate the target volume 106 while at least part of the LINAC 102 rotates about the target volume 106. For example, the LINAC 102 may be attached to a gantry (e.g., an L-shaped gantry; not shown) operable to rotate at least the part of the LINAC 102 about the target volume 106 before, during, and/or after the irradiation of the target volume 106. The first detector 108 may be disposed opposite the LINAC 102 (e.g., opposite a treatment head of the LINAC 102) and may extend in a direction approximately perpendicular to a central axis of the treatment beam. The first detector 108 may be movably or rigidly attached to the gantry, such that the first detector 108 is operable to rotate about the target volume 106 with the LINAC 102. In one embodiment, the first detector 108 may be attached to the gantry via an extendible and retractable housing. The first detector 108 may be modular and may be positioned in the extendible and retractable housing when the first imaging device is to be used. By detecting 2D data at different angles relative to the patient, the 2D datasets may be further processed to generate three-dimensional (3D) datasets.

The radiation therapy system 100 also includes a second imaging device 110. The second imaging device 110 is an X-ray device that includes a second radiation source 112 and a second radiation detector 114 (e.g., a second detector). The second radiation source 112 may generate a beam of X-rays (e.g., kV X-rays). In one embodiment, the second radiation source 112 is the LINAC 102, and the treatment beam is modified to deliver the kV X-rays. The second radiation detector 114 may generate two-dimensional (2D) datasets representing the target volume 106 based on the kV X-rays generated by the second radiation source 112. The 2D datasets may be further processed to generate three-dimensional (3D) datasets (e.g., volumetric datasets).

The second detector 114 may, for example, be a flat-panel detector. In one embodiment, the second detector 114 includes a scintillator layer and solid-state amorphous silicon photodiodes deployed in a two-dimensional array. In another embodiment, the kV X-rays are absorbed directly by an array of amorphous selenium photoconductors. The photoconductors convert the kV X-rays directly to stored electrical charge that represents an acquired image of the target volume 106. Other detectors may be used.

The second imaging device 110 (e.g., the second radiation source 112 and the second detector 114) may be operable to move about the target volume 106 with or independent from the first imaging device (e.g., relative to the first imaging device). In one embodiment, the second radiation source 112 and the second detector 114 may be movably or rigidly attached to the gantry, such that the second radiation source 112 and the second detector 114 are operable to rotate about the target volume 106 with or independent from the LINAC 102 and the first detector 108. In one embodiment, the second detector 114 may be attached to the gantry via an extendible and retractable housing. In another embodiment, the second detector 114 may be attached to the gantry via an arm that is rotatable relative to the gantry. The second detector 114 may be modular and may be positioned in the extendible and retractable housing or on the arm when the second imaging device is be used.

In one embodiment, the second radiation source 112 and the second detector 114 may be supported by a C-arm that is separate from the gantry, on which the LINAC 102 and the first detector 108 are supported. The second radiation source 112 and the second detector 114 may be supported by the C-arm, such that the second detector 114 is directly opposite the second radiation source 112, with the second detector 114 extending in a direction perpendicular to a central axis of the beam of kV X-rays generated by the second radiation source 112. The C-arm may be attached to a robot operable to move the second imaging device 110 with six degrees of freedom. Other supports for the second radiation source 112 and the second detector 114 may be used.

During radiation therapy for the target volume 106 (e.g., the tumor), the second imaging device 110 may track movement of the target volume 106. The second imaging device 110 may track movement of the target volume 106 when the treatment beam in on, when the treatment beam is off, or a combination thereof. In order to track the movement of the target volume 106 during the radiation therapy, the second imaging device 110 generates data representing the target volume 106 and a region outside the target volume 106 during the radiation therapy. The second imaging device 110 may be positioned in any number of positions relative to the LINAC 102 (e.g., the first imaging device) during the radiation therapy. For example, the second radiation source 112 may be positioned directly opposite the treatment head of the LINAC 102, below the target volume 106, such that the second imaging device 110 may image the target volume 106 from below the target volume while the treatment beam 104 from the LINAC 102 irradiates the target volume 106 (e.g., the treatment beam may pass through the second detector 114). Alternatively or additionally, the second imaging device 110 (e.g., the second radiation source 112 and the second detector 114) may be rotated out of the beam path of the treatment beam 104 when the treatment beam 104 is on, and may be rotated into the beam path of the treatment beam 104 when the treatment beam 104 is off.

Some of the 2D datasets generated by the second imaging device 110 and/or the first imaging device may be obtained contemporaneously with the planning of a medical treatment procedure (e.g., to irradiate and destroy cancerous tissue within the target volume 106). For example, the second imaging device 110 may be used to create a patient model that may be used in the planning of the medical treatment procedure (e.g., part of a treatment plan). The second imaging device 110 may be used instead of the first imaging device to create the patient model, as the kV X-rays may produce better contrast and thus better image quality in the resultant images than the MV X-rays. In other embodiments, the second imaging device 110 may be a computed tomography (CT) device, a positron emission tomography (PET) device, an angiography device, a fluoroscopy device, or an ultrasound device.

The radiation therapy system 100 also includes a controller 116 in communication with a memory 118. The controller 116 may be in communication with and control the LINAC 102, the first imaging device (e.g., the first detector 108), and/or the second imaging device 110 (e.g., the second radiation source 112 and the second detector 114). For a radiation therapy of the target volume 106, the LINAC 102 may be controlled based on a treatment plan 120 stored in the memory 118, for example.

The controller 116 is a general processor, a central processing unit, a control processor, a graphics processor, a digital signal processor, a three-dimensional rendering processor, an image processor, an ASIC, a field-programmable gate array, a digital circuit, an analog circuit, combinations thereof, or another now known or later developed controller. The controller 116 is a single device or multiple devices operating in serial, parallel, or separately. The controller 116 may be a main processor of a computer such as a laptop or desktop computer, or may be a processor for handling some tasks in a larger system. For example, the controller 116 may be a processor of the therapy system 100. The controller 116 is configured by instructions, design, hardware, and/or software to perform the acts discussed herein, such as calibrating an imaging system (e.g., the first imaging device and the second imaging device 110) of the radiation therapy system 100.

The memory 118 is a non-transitory computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 118 may be a single device or a combination of devices. The memory may be adjacent to, part of, networked with and/or remote from the controller 116.

For the radiation therapy of the target volume 106, the LINAC 102 and other components of the radiation therapy system 100 such as, for example, the multileaf collimator may be controlled based on the 2D data and/or the 3D data generated by the second imaging device 110 and/or the first imaging device and the treatment plan 120 stored in the memory 118, such that radiation reaching a region outside of the target volume 106 may be minimized. The treatment plan 120 includes a three-dimensional representation of the target volume 106 generated before conducting the medical treatment procedure. The three-dimensional representation of the treatment volume 106 may be generated using the second imaging device 110 or another imaging device, for example. The treatment plan 120 also includes, for example, a sequence of delivery segments, within which discrete points are described by, for example, a beam shape (i.e., a shape and/or an orientation of a beam shaping device), a beam dose, a beam energy, and/or gantry angles defining a range or span of the segment (e.g., an upper limit and a lower limit), within which the radiation dose is to be delivered.

In one embodiment, the treatment plan 120 is for an intensity modulated radiation therapy (IMRT) methodology, where the gantry of the LINAC 102 delivers radiation to the target volume 106 at one or more gantry angles. The IMRT methodology may be a step-and-shoot IMRT methodology, where the gantry of the LINAC 102 rotates and stops at one or more gantry angles, at which the LINAC 102 delivers radiation to the target volume 106. Alternatively, the LINAC 102 may deliver radiation to the target volume 106 while the gantry of the LINAC 102 is rotating. The LINAC 102 may deliver radiation to the target volume 106 continuously during rotation of the gantry, or may deliver radiation to the target volume 106 in segments (e.g., 15 degrees to 30 degrees and 45 degrees to 60 degrees) of the rotation of the gantry.

The controller 116 may register data (e.g., 2D data and 3D data) generated with the first imaging device and data (e.g., 2D data and 3D data) generated with the second imaging device 110 with the LINAC 102. For example, data generated by the first imaging device and the second imaging device 110 may be transformed into a coordinate system of the LINAC 102. Any number of registration methods may be used. In other embodiments, the controller 116 may register the first imaging device and/or the second imaging device 110 with the LINAC 102. Coordinate systems of the data generated with the first imaging device and the second imaging device 110, respectively, are registered with the coordinate system of the LINAC 102, so that data obtained with the first imaging device may be compared and integrated with data obtained with the second imaging device 110, and accurate irradiation with the LINAC 102 may be provided.

To aid in the registration of the data generated with the first imaging device and the data generated with the second imaging device 110 (e.g., calibration of the first imaging device and the second imaging device 110), a calibrated reticle 122 may be disposed in a beam path of the treatment beam 104. The reticle 122 is calibrated in that the reticle 122 indicates a projected origin of the coordinate system of the LINAC 102 (e.g., an isocentric coordinate system) from any projection angle. The reticle 122 may be inside a housing of LINAC 102 or outside the housing of the LINAC 102. The reticle 122 may be a cross-hair made of, for example, metallic wires. The reticle 122 may also take other forms.

Also to aid in the registration of the data generated with the first imaging device and the data generated with the second imaging device 110, a phantom may be used as the target volume 106. The phantom 106 may be, for example, cylindrical in shape and may include one or more markers 124 (e.g., 108 markers). The markers 124 may be arranged in a helix on an outer surface of the phantom 106. The markers 124 may include sets of different sized markers. Each of the markers 124 may be a semi-spherical bead, for example. The phantom 106 may be any number of other shapes. More or fewer markers 124 may be included, the markers may be shaped differently, and/or the markers may be arranged in a different shape on the outer surface of the phantom. The phantom may be positioned relative to the LINAC 102 and the second imaging device 110 in any number of ways.

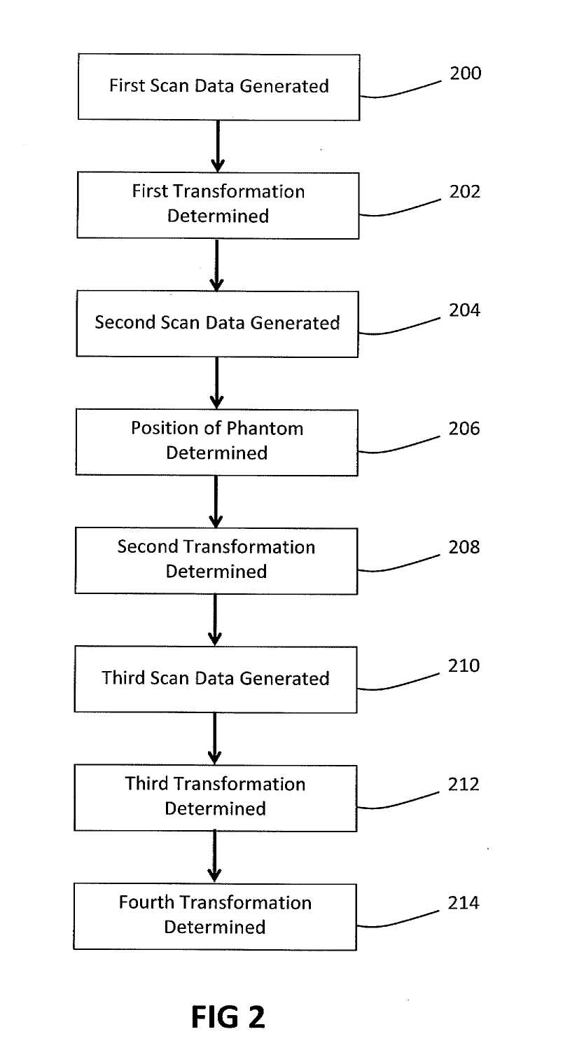

FIG. 2 shows a flowchart of one embodiment of a method for calibrating an imaging system of an image-guided treatment system. The method may be performed using the first imaging device and the second imaging device 110 of the radiation treatment system 100 shown in FIG. 1 or another imaging system of another radiation treatment system. The method is implemented in the order shown, but other orders may be used. Additional, different, or fewer acts may be provided. Similar methods may be used for calibrating an imaging system.

The image-guided treatment system includes a radiotherapy device (e.g., a LINAC) operable to generate a treatment beam including MV X-rays for irradiating a target volume (e.g., a tumor in a patient) positioned on a patient table. The image-guided treatment system may include a first imaging device and a second imaging device.

The first imaging device (e.g., an MV imaging device) may include a first detector disposed opposite from the radiotherapy device, and the radiotherapy device may act as a first radiation source (e.g., a first source) of the first imaging device. The radiotherapy device and the first detector may be supported by a gantry. The gantry may be rotatable about an axis of rotation, such that the target volume may be irradiated with the MV X-rays from a plurality of directions (e.g., a plurality of gantry angles). The first detector may be a flat panel detector, for example, and may be supported in a housing (e.g., an extendible and retractable housing) of the gantry. A face of the first detector may be approximately perpendicular to a central axis of the treatment beam. Due to tolerances between the first detector and the housing of the gantry, however, the first detector may not be exactly aligned with the radiotherapy device (e.g., a line through the first radiation source and an isocenter of the radiotherapy device may not intersect with a central point of the first detector).

The second imaging device (e.g., a kV imaging device) may include a second radiation source (e.g., a second source) and a second detector. In one embodiment, the second radiation source may be the first radiation source, and the treatment beam may be modified to generate kV X-rays. In another embodiment, the second radiation source is different than the first radiation source. The second radiation source and the second detector may be movably or rigidly attached to the gantry at different locations on the gantry than the first radiation source and the first detector. Alternatively, the second radiation source and the second detector may be supported by a support separate from the gantry. The support may, for example, be a C-arm having six degrees of motion operable to be rotated about the target volume.

In act 200, first scan data is generated using the MV imaging device. A reticle may be disposed in a beam path of the treatment beam when the first scan data is generated. The first scan data may be 2D data (e.g., MV 2D data) that represents the reticle. The reticle may be calibrated in that the reticle identifies a projected isocenter from any beam direction of the treatment beam. The gantry may be rotated, and first scan data may be generated from a first plurality of directions (e.g., a plurality of projection angles of the MV imaging device relative to the patient or region for the patient). The MV imaging device may forward the first scan data to a memory of the image-guided treatment system, and the memory may store the first scan data.

In act 202, a first transformation is determined based on the first scan data. The first transformation is between a coordinate system of the radiotherapy device (e.g., at least two dimensions of an isocentric coordinate system; a coordinate system of a treatment room, in which the image-guided treatment system is disposed; a first coordinate system) and a 2D image coordinate system of the MV imaging device (e.g., a second coordinate system; at least two dimensions of a second coordinate system; the MV 2D coordinate system).

A processor of the image-guided treatment system may identify the 2D first scan data in the memory and further process the 2D first scan data to generate 2D images (e.g., MV 2D images) of the reticle from the first plurality of directions. The processor may use line profiles, filtering, binarization, template matching, and/or thresholds, for example, to detect the reticle in each of the generated 2D images. Other image processing methods may be used to detect the reticle in each of the generated 2D images.

From a position of the reticle in each of the generated 2D images, a translation (e.g., in x- and y-directions parallel to a face of the first detector) and a rotation (e.g., about a z-axis perpendicular to the x- and y-directions) of the first detector with respect to the isocentric coordinate system may be determined. The origin of the first detector may be at a point of the first detector where a line joining the first radiation source and an isocenter of the radiotherapy device (e.g., isocentric ray) intersects the first detector. Other origins may be used. The first detector may, for example, be assumed to be perpendicular to the isocentric ray, and a distance between the first radiation source and the first detector may be assumed to be constant. Warping or alteration of angles of the detected reticle may instead be used to determine any deviation away from perpendicular.

The first transformation may, for example, be represented using the DICOM standard. For example, offsets in the x-direction, the y-direction, and the z-direction (e.g., constant) parallel to the face of the first detector may be defined by 3002,000D, and the rotation phi about the z-axis may be defined by 3002,000E. Using the first transformation, MV 2D image coordinates may be determined at each projection angle of the first plurality of projection angles. Interpolation may be used to determine MV 2D image coordinates at projection angles different than the first plurality of projection angles. The position of the reticle may be determined in each of the generated 2D images because forces (e.g., gravitational forces) and/or torques on the first source, the first detector, and/or other components of the radiation therapy system may differ based on positions of the first source and/or the first detector within a rotation. Accordingly, depending on positions of the first source and/or the first detector within the rotation, positions of the first source and/or the first detector relative to the isocenter may change. Additionally, tolerances between different parts of the image-guided treatment system may cause different translations and/or rotations of the first detector with respect to the isocentric coordinate system at different positions of the first detector within the rotation.

In act 204, second scan data is generated using the MV imaging device. A phantom (e.g., the target volume) may be positioned within the field of view of the first imaging device. The second scan data may represent the phantom. In one embodiment, the phantom is cylindrical in shape and includes a plurality of markers arranged in a helical pattern on an outside surface of the phantom. The plurality of markers may include different sized markers arranged in an irregular pattern, such that each marker of the plurality of markers may be identified. The MV imaging device may forward the second scan data to the memory of the image-guided treatment system, and the memory may store the second scan data.

The gantry may be rotated, and the second scan data may be generated from a second plurality of directions (e.g., a second plurality of projection angles of the MV imaging device). The second plurality of projection angles may be the same or different than the first plurality of projection angles. The second plurality of projection angles may include more or fewer angles than the first plurality of projection angles. In one embodiment, some projection angles of the second plurality of projection angles are the same as some projection angles of the first plurality of projection angles.

In one embodiment, second scan data may be generated at each projection angle of the second plurality of projection angles a number of times (e.g., three hundred and sixty times; three hundred and sixty projection images generated at each projection angle of the second plurality of projection angles). The processor of the image-guided treatment system may identify the 2D second scan data in the memory and further process the 2D second scan data to generate 2D images (MV 2D images) of the phantom from the second plurality of directions. The processor may use line profiles and thresholds, for example, to detect and identity at least some markers of the plurality of markers within the MV 2D images at each projection angle of the second plurality of projection angles. Other image processing to identify the markers may be used. The processor may determine coordinates of the markers in the MV 2D coordinate system at each projection angle of the second plurality of projection angles. Since the phantom maintains a position while the MV imaging device rotates to different angles, the locations of the markers for each angle may be different.

In act 206, a position of the phantom in the isocentric coordinate system is determined based on the second scan data and the first transformation. The processor may determine coordinates of the markers in the isocentric coordinate system (e.g., at each projection angle of the second plurality of projection angles) based on the first transformation and the determined coordinates of the markers in the MV 2D coordinate system. The first transformation relates the MV 2D coordinate system to the isocentric coordinate system.

The processor may determine a 3D rigid transformation A that is optimal with respect to differences between the determined coordinates of the markers in the MV 2D coordinate system and a corrected phantom position. For each determined marker coordinate within the MV 2D coordinate system m_{i,b}=(x_{FP}, y_{FP})_{i,b} with ID i and projection angle b, a distance d_{i,b} may be determined from the projected position mᵢ=(x_{IEC}, y_{IEC}, z_{IEC}), in the isometric coordinate system (e.g., 3D isometric coordinate system). The distance d is defined as:

d_{i,β}=∥m_{i,β}−P^{β}·A·mᵢ∥₂.

The transformation A is defined by A(tₓ, t_{y}, t_{z}, aₓ, a_{y}, a_{z})=Rₓ·R_{y}·R_{z}·T, where T includes the translations, and R includes the rotations about the x-, y-, and z-axes. The parameters for translation are tₓ, t_{y}, t_{z}, and the parameters for rotation are aₓ, a_{y}, a_{z}. The ideal projection matrix P^{β}, which is dependant on the projection angle β, is defined as follows:

$${P}^{β} = [ \begin{matrix}\frac{SID / {p}_{x} cos β - {u}_{0} sin β}{SAD} & 0 & \frac{- SID / {p}_{x} sin β - {u}_{0} cos β}{SAD} & {u}_{0} \\ \frac{- {v}_{0} sin β}{SAD} & \frac{- SID / {p}_{y}}{SAD} & \frac{- {v}_{0} cos β}{SAD} & {v}_{0} \\ \frac{- sin β}{SAD} & 0 & \frac{- cos β}{SAD} & 1\end{matrix} ] .$$

The parameters SID, SAD, pₓ, p_{y}, u₀, v₀ (e.g., six parameters) may be scaling factors and may describe the geometry of the first detector. The six parameters define the transformation for an ideal imaging system without movement of the first detector with respect to the first source and with movement of the first source and the first detector around the isocenter in a perfect circle. SID, which represents the source to image distance, is the distance from the first source to the first detector (e.g., a panel of the first detector) through the isocenter. The SID may be known from the mechanical setup of the first imaging device. SAD, which represents the source axis distance, is the distance from the first source to the isocenter. The SAD may also be known from the mechanical setup of the first imaging device. pₓ and p_{y} are detector pixel dimensions along x and y axes. pₓ and p_{y} may be known properties of the first detector. u₀, v₀ define a pixel origin (e.g., a position of an isocentric ray in pixel coordinates) on the first detector (e.g., the panel of the first detector). u₀, v₀ may be determined from the first transformation determined from the first scan data with the reticle. The 6 parameters of A are optimal when the sum over all distances d_{i,b} (e.g., over all detected markers and over all MV 2D projection images of the phantom) is minimal:

$$A = {min}_{{t}_{x} , {t}_{y} , {t}_{z} , {α}_{x} , {α}_{y} , {α}_{z}} \{ {\sum }_{i , β} {d}_{i , β} \}$$

There are numerous markers on the phantom, and each detected marker results in one linear equation with eleven unknowns. The detected markers (e.g., a minimum of 11) result in an over-determined linear system of equations, the solution of which defines the eleven unknown parameters in a least-squared sense. The scaling factors SID and SAD depend on an interpretation of DICOM attributes for correcting the position of the first detector.

In act 208, a second transformation is determined based on the second scan data and the determined position of the phantom. The second transformation is between the isocentric coordinate system (e.g., three dimensions of the isocentric coordinate system) and the MV 2D coordinate system (e.g., the second coordinate system; at least two dimensions of the second coordinate system). From the second scan data of the phantom generated using the MV imaging device in act 204 and the position of the phantom determined in act 206, actual projection matrices P^{β} may be determined for each projection angle of the second plurality of projection angles.

In act 210, third scan data is generated using the kV imaging device. The third scan data may represent the phantom. The phantom (e.g., the target volume) remains in the same position within the isocentric coordinate system from when the second scan data was generated. The kV imaging device may forward the third scan data to the memory of the image-guided treatment system, and the memory may store the third scan data. Any scan format or process may be used to reconstruct a three-dimensional representation from the kV imaging device.

The gantry or another support supporting the kV imaging device may be rotated, and the third scan data may be generated from a third plurality of directions (e.g., a first plurality of projection angles of the kV imaging device). The third plurality of projection angles may be the same or different than the first plurality of projection angles and/or the second plurality of projection angles.

The processor of the image-guided treatment system may identify the 2D third scan data in the memory and further process the 2D third scan data to generate 2D images (kV 2D images) of the phantom from the third plurality of directions. The processor may use line profiles and thresholds, for example, to detect and identity at least some markers of the plurality of markers within the kV 2D images at each projection angle of the third plurality of projection angles. Other image processing to identify the markers may be used. The processor may determine coordinates of the markers in the kV 2D coordinate system at each projection angle of the third plurality of projection angles. Since the phantom maintains a position while the kV imaging device rotates to different angles, the locations of the markers for each angle may be different.

From the kV 2D marker coordinates at each projection angle of the third plurality of projection angles and the 3D marker positions in the isocentric coordinate system mᵢ for each projection angle, the kV projection matrices P^{β} may be determined. The kV projection matrices define the transformation from the isocentric coordinate system to the kV 2D image coordinates:

mᵢ^{2D}=P^{β}·mᵢ^{3D}

The projection matrices have 12 parameters. Out of 108 markers of the phantom, for example, 75 markers may be identified/determined in a projection image. The determination of the projection matrices is equivalent to solving an over-determined set of linear equations that may be solved optimally with standard numerical algorithms.

In act 212, a third transformation is determined based on the determined position of the phantom and the third scan data. The third transformation is between the isocentric coordinate system (e.g., three dimensions of the isocentric coordinate system) and a 2D image coordinate system of the kV imaging device (e.g., a third coordinate system; at least two dimensions of the third coordinate system; the kV 2D coordinate system). The actual projection matrices P^{β} for the third transformation may be determined from the kV 2D images of the phantom generated in act 210 and the position of the phantom determined in act 206.

In act 214, a fourth transformation is determined based on the third transformation. The fourth transformation is between the isocentric coordinate system (e.g., at least two dimensions of the isocentric coordinate system) and the kV 2D coordinate system (e.g., the third coordinate system; at least two dimensions of the third coordinate system). From the kV projection matrices of act 212, for each projection angle of the third plurality of projection angles, the DICOM attributes may be determined to define the kV 2D image coordinates with respect to the isocentric coordinate system.

For example the alignment of the kV 2D images with respect to the isocentric coordinates is defined by a translation and a rotation of a center of the image in the isocentric coordinate system. The translation is determined by transforming the isocenter (coordinates (0,0,0)) with the kV projection matrix as determined in act 212, and subtracting the resulting kV 2D image coordinates from coordinates of the center of the image. The rotation of the kV 2D images may be determined by transforming a vector (0,1,0) with the kV projection matrix and determining slope of the resulting vector. The fourth transformation, which relates to the kV imaging device, corresponds to the first transformation, which relates to the MV imaging device (e.g., including the radiotherapy device). Like the first transformation, the fourth transformation may, for example, be represented using the DICOM standard. The fourth transformation may be used for patient positioning in order to be able to compare 2D images from the actual patient position with 2D images used for treatment planning or 2D images generated by a treatment planning system. The treatment planning system may include, for example, a dedicated imaging device used to create a planning data set (e.g., a dedicated CT imaging device). The images generated by the treatment planning system use the isocentric coordinate system. Therefore, the 2D images generated by the kV imaging device (e.g., including the radiotherapy device) are transformed into the isocentric coordinate system using the fourth transformation.

To summarize, the first transformation is from 2D image coordinates of the first detector to 2D isocenter coordinates (e.g., of the radiotherapy device). The second transformation is from 3D isocenter coordinates to 2D angle dependent image coordinates (e.g., pixel coordinates) of the first detector (e.g., the MV detector). The third transformation is from the 3D isocenter coordinates to 2D angle dependent image coordinates (e.g., pixel coordinates) of the second detector (e.g., the kV detector). The fourth transformation is from 2D image coordinates of the second detector to 2D isocenter coordinates. The first transformation and the fourth transformation (e.g., the 2DMV and 2DkV transformations) are used for position verification with 2D images (e.g., radiographs or digitally reconstructed radiographs (DRRs) created by a treatment planning system). The second transformation and the third transformation (e.g., the 3DMV and 3DkV transformations) are used for position verification with, for example, 3D computed tomography (CT) images (e.g., to generate 3D images from the radiographs or the DRRs created by the treatment planning system).

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for calibrating an imaging system of a radiation treatment system, the method comprising:
receiving, from a first imaging device of the imaging system, first scan data of a reticle disposed in a beam path of a treatment beam, a radiation treatment device of the radiation treatment system being operable to generate the treatment beam;
determining a first transformation based on the first scan data, the first transformation being between at least two dimensions of a first coordinate system and a second coordinate system, the first coordinate system being a coordinate system of the radiation treatment device, the second coordinate system being an image coordinate system of the first imaging device;
receiving, from the first imaging device, second scan data, the second scan data being of a phantom comprising at least one marker;
determining a position of the phantom in the first coordinate system based on the first transformation and the second scan data; and
determining a second transformation based on the second scan data and the determined position of the phantom, the second transformation being between three dimensions of the first coordinate system and the second coordinate system.

2. The method of claim 1, wherein the radiation treatment system is operable to irradiate a patient with the treatment beam from a plurality of different directions relative to the patient,
wherein the received first scan data represents the reticle as scanned from a first subset of directions of the plurality of different directions, and
wherein the received second scan data represents the phantom as scanned from a first plurality of directions relative to the phantom.

3. The method of claim 2, further comprising determining data representing the reticle as scanned from one or more directions different than the first subset of directions by interpolating the received first scan data.

4. The method of claim 2, wherein the first scan data comprises first scan subsets, each of the first scan subsets comprising data representing the reticle as scanned from one direction of the first subset of directions, and
wherein determining the first transformation comprises:
detecting the reticle in each of the first scan subsets; and
determining, for each of the first scan subsets, a translation, a rotation, or the translation and the rotation of a detector of the first imaging device relative to the first coordinate system based on the detected reticle.

5. The method of claim 4, wherein the second scan data comprises second scan subsets, each of the second scan subsets comprising data representing the phantom as scanned from one direction of the first plurality of directions relative to the phantom,
wherein the at least one marker comprises a plurality of markers, and
wherein determining the position of the phantom in the first coordinate system comprises:
identifying at least some markers of the plurality of markers in each of the second scan subsets;
determining, in each of the second scan subsets, coordinates of the at least some markers in the second coordinate system; and
determining coordinates of the at least some markers in the first coordinate system based on the first transformation and the determined coordinates of the at least some markers in the second coordinate system.

6. The method of claim 5, wherein determining the second transformation comprises minimizing a sum of differences between the determined coordinates of the at least some markers in the second coordinate system and the determined coordinates of the at least some markers in the first coordinate system over all of the second scan subsets.

7. The method of claim 2, wherein the imaging system comprises a second imaging device, and
wherein the method further comprises:
receiving, from the second imaging device, third scan data, the third scan data representing the phantom as scanned from a second plurality of directions relative to the phantom;
determining a third transformation based on the determined position of the phantom and the third scan data, the third transformation being between three dimensions of the first coordinate system and a third coordinate system; and
determining a fourth transformation based on the third transformation, the fourth transformation being between at least two dimensions of the first coordinate system and the third coordinate system.

8. The method of claim 7, wherein the first plurality of directions relative to the phantom are the same as the second plurality of directions relative to the phantom.

9. The method of claim 7, wherein a radiation source of the radiation treatment device and a radiation source of the first imaging device are the same radiation source.

10. The method of claim 7, wherein the third coordinate system is a 2D image coordinate system of the second imaging device.

11. The method of claim 7, wherein the phantom is in the same position in the first coordinate system when the second scan data is received from the first imaging device and when the third scan data is received from the second imaging device.

12. A system for calibrating an imaging system of a radiation treatment system, the radiation treatment system being operable to irradiate a patient with a treatment beam from a plurality of different directions relative to the patient, the system comprising:
an input operable to:
receive first scan data from a first imaging device of the imaging system, the first scan data representing a reticle as scanned from a first subset of directions of the plurality of different directions, the reticle being disposed in a beam path of the treatment beam;
receive second scan data from the first imaging device, the second scan data representing a phantom as scanned from a first plurality of directions relative to the phantom, the phantom comprising a plurality of markers; and
receive third scan data from a second imaging device of the imaging system, the third scan data representing the phantom as scanned from a second plurality of directions relative to the phantom; and
a processor configured to:
determine a first transformation based on the first scan data, the first transformation being between at least two dimensions of a first coordinate system and a second coordinate system;
determine a position of the phantom in the first coordinate system based on the first transformation and the second scan data;
determine a second transformation based on the second scan data and the determined position of the phantom, the second transformation being between three dimensions of the first coordinate system and the second coordinate system; and
determine a third transformation based on the determined position of the phantom and the third scan data, the third transformation being between three dimensions of the first coordinate system and a third coordinate system.

13. The system of claim 12, wherein the processor is further configured to determine a fourth transformation based on the third transformation, the fourth transformation being between at least two dimensions of the first coordinate system and the third coordinate system.

14. The system of claim 12, wherein a radiation source of the first imaging device is a MV radiation source, and a radiation source of the second imaging device is a kV radiation source.

15. The system of claim 12, wherein the plurality of markers is arranged in a helix on the phantom.

16. In a non-transitory computer-readable storage medium that stores instructions executable by one or more processors to calibrate an imaging system of a radiation treatment system, the instructions comprising:
identifying first scan data for a reticle disposed in a beam path of a treatment beam of the radiation treatment system;
determining a first transformation based on the first scan data, the first transformation being between at least two dimensions of a first coordinate system and a second coordinate system;
identifying second scan data, the second scan data being for a phantom comprising at least one marker;
determining a position of the phantom in the first coordinate system based on the first transformation and the second scan data;
determining a second transformation based on the second scan data and the determined position of the phantom, the second transformation being between three dimensions of the first coordinate system and the second coordinate system;
identifying third scan data, the third scan data being for the phantom;
determining a third transformation based on the determined position of the phantom and the third scan data, the third transformation being between three dimensions of the first coordinate system and a third coordinate system; and
determining a fourth transformation based on the third transformation, the fourth transformation being between at least two dimensions of the first coordinate system and the third coordinate system.

17. The non-transitory computer-readable storage medium of claim 16, wherein the radiation treatment system is operable to irradiate a patient with the treatment beam from a plurality of different directions relative to the patient, and the imaging system comprises a first imaging device and a second imaging device, the first imaging device being operable to image the patient using the treatment beam from the plurality of different directions,
wherein identifying first scan data comprises receiving the first scan data from the first imaging device, the first scan data representing the reticle as scanned from a first subset of directions of the plurality of different directions,
wherein identifying second scan data comprises receiving the second scan data from the first imaging device, the second scan data representing the phantom as scanned from a first plurality of directions relative to the phantom, and
wherein identifying third scan data comprises receiving the third scan data from the second imaging device, the third scan data representing the phantom as scanned from a second plurality of directions relative to the phantom.

18. The non-transitory computer-readable storage medium of claim 17, wherein the first scan data comprises first scan subsets, each of the first scan subsets comprising data representing the reticle as scanned from one direction of the plurality of different directions; and
wherein determining the first transformation comprises:
detecting the reticle in each of the first scan subsets; and
determining, for each of the first scan subsets, a translation, a rotation, or the translation and the rotation of a detector of the first imaging device relative to the first coordinate system based on the detected reticle.

19. The non-transitory computer-readable storage medium of claim 17, wherein the second scan data comprises second scan subsets, each of the second scan subsets comprising data representing the phantom as scanned from one direction of the first plurality of directions relative to the phantom,
wherein the at least one marker comprises a plurality of markers, and
wherein determining the position of the phantom in the first coordinate system comprises:
identifying at least some markers of the plurality of markers in each of the second scan subsets;
determining, in each of the second scan subsets, coordinates of the at least some markers in the second coordinate system; and
determining coordinates of the at least some markers in the first coordinate system based on the first transformation and the determined coordinates of the at least some markers in the second coordinate system.

20. The non-transitory computer-readable storage medium of claim 19, wherein the phantom is in the same position in the first coordinate system when the second scan data is scanned and when the third scan data is scanned.
